(19) United States
(12) Patent Application Publication
(10) Pub. No.: US 2006/0039251 A1
(43) Pub. Date: Feb. 23, 2006

(54) Method and apparatus for controlling layer jumping of pickup head of optical disk drive

(75) Inventor: Li-Ting Chen, Taipei (TW)

Correspondence Address: BRUCE H. TROXELL, SUITE 1404, 5205 LEESBURG PIKE, FALLS CHURCH, VA, 22041, US

(73) Assignee: ALi Corporation

(21) Appl. No.: 11/149,249

(22) Filed: Jun. 10, 2005

(30) Foreign Application Priority Data
Aug. 17, 2004 (TW) 93124598

(51) Int. Cl. G11B 7/00

(52) U.S. Cl. 369/44.28; 369/44.27; 369/44.29

(57) ABSTRACT

The invention discloses a device and a method for controlling the layer jumping of a pickup head, and the device includes a speed detector, a target speedometer, a first adder, a compensator, a gap balance signal calculator, and a second adder; wherein the speed detector receives a combined reflective light signal from a preamplifier to output a layer jumping speed signal; the target speedometer outputs a target layer jumping speed signal; the first adder adds the layer jumping speed signal and the target layer jumping speed signal and outputs the sum; the compensator receives and compensates the output from the first adder; the gap balance calculator receives a focus control signal to output a gap balance signal; the second adder adds a kickout/brake signal, the gap balance signal and the output of the compensator and outputs a control signal to a driver for controlling a pickup head.

### 1. FIELD OF THE INVENTION

The present invention relates to a method and an apparatus for controlling the layer jumping of a pickup head of an optical disk drive, and more particularly, to a method and an apparatus for controlling the layer jumping of a pickup head by means of a combined reflective light.

### 2. BACKGROUND OF THE INVENTION

At present, there are a number of different types of DVD discs such as the single-sided single-layer DVD disks, single-sided dual-layer DVD disks, double-sided single-layer DVD disks, and double-sided dual-layer DVD disks. Therefore, the pickup head in a DVD disk drive must be designed according to the layer jumping mechanism for the single-sided or double-sided dual-layer optical disks.

Please refer to FIG. 1 for a schematic view of the pickup head reading a dual-layered DVD disk. In FIG. 1, a voice coil motor 120 controls the vertical displacement of an objective lens of a pickup head. If the pickup head is not being used for reading a DVD disk (not shown in the figure), the objective lens is positioned at an equilibrium position. If the pickup head intends to read the outer layer of the DVD disk, then the voice coil motor 120 applies a force to control and move the objective lens 110 from its equilibrium position B to a position L0 with a displacement D0. If the pickup head intends to read the inner layer of the DVD disk, the voice coil motor 120 applies a force to control and move the objective lens 110 from the equilibrium position B to a position L1 with a displacement D1.

Please refer to FIG. 2 for the schematic circuit diagram of controlling the layer jumping of a pickup head according to a prior art. First of all, the feedback control for a tracking performed by a pickup head 210 is described as follows: a preamplifier 220 receives a signal outputted during the tracking performed by the pickup head 210 to output a focus error signal; a controller 230 outputs a focus control signal according to the focus error signal to control the pickup head 210. In most cases, the pickup head 210 jumps from a layer to another layer during its tracking. Therefore, when the pickup head 210 is jumping from a layer to another layer, the DVD disk will send a layer jumping control signal to control an electronic switch 260 to switch the receiving path of a driver 250. An open loop is formed between the driver 250 and the pickup head 210, in which a low-pass filter 240 receives the focus control signal to output a gap balance signal as the DC potential of a kickout/brake signal. After combining the gap balance signal and the kickout/brake signal by an adder 247 to form a combined signal, the resulting combined signal will be used as a control signal for directing the driver 250 to output a drive control force and controlling the layer jumping of the pickup head 210.

Please refer to FIG. 3 for the schematic view of the signal of controlling the layer jumping of the pickup head as depicted in FIG. 2. The descending edge of a layer jumping control signal represents that the pickup head starts jumping layer, where the potential of a gap balance signal outputted a low-pass filter after a focus control signal is received by the same will be pulled to a high level indicating that the pickup head is subjected to a force for perform layer jumping, and the pickup head starts its displacement for the layer jumping by the force until a kickout signal and brake signal are sent out. The transmission of these signals respectively indicate that no force is applied to the pickup head and the pickup head still keeps on sliding, and a force is applied in the direction opposite to the previous layer jumping force onto the pickup head such that the pickup head stops jumping from a layer to another layer by the resisting force.

As to the overall tracking and layer jumping of the pickup head, at the moment of the pickup head switches its movements from focusing to layer jumping, the signal received by the driver 250 is not continuous. During the layer jumping period, the driver 250 and the pickup head 210 are open looped. Therefore, the pickup head 210 will not have any feedback control during the layer jumping period as to respond to the layer jumping of the pickup head 210 operated in a high-speed DVD disk drive. If the pickup head 210 jumps from a layer to another layer while a DVD disk drive is operating in high-speed, then the mechanism vibration caused by the high-speed rotation is intensified by the fast rotating DVD disk that causes the no feedback control is feasible for pickup head 210 during the layer jumping period. In other words, the driver 250 cannot provide an appropriate drive control force to overcome the inertia and acceleration produced when the pickup head 210 jumps from a layer to another layer and operates in a DVD disk drive operating in high-speed.

In view of the foregoing shortcomings, the present invention provides a method and an apparatus for controlling the layer jumping of a pickup head of an optical disk drive capable of producing a feedback control when the pickup head jumps from a layer to another layer while DVD optical disk drive is operating in high-speed so as to enhance the stability of the pickup head of the DVD optical disk during the layer jumping.

### SUMMARY OF THE INVENTION

The primary objective of the invention is to provide a device for controlling the layer jumping of a pickup head, which comprises a speed detector, a target speedometer, a first adder, a compensator, a gap balance signal calculator, and a second adder; wherein the speed detector receives a combined reflective light signal from a preamplifier to output a layer jumping speed signal; the target speedometer outputs a target layer jumping speed signal; the first adder adds the layer jumping speed signal and the target layer jumping speed signal and outputs the error signal; the compensator receives and compensates the output from the first adder; the gap balance calculator receives a focus control signal to output a gap balance signal; the second adder adds a kickout/brake signal, the gap balance signal and the output of the compensator and outputs a control signal to a driver for controlling a pickup head according to the control signal.

In a preferred embodiment of the present invention, the optical disk drive is a DVD disk drive; the speed detector is a differentiator; and the target speedometer is a multi-sectional adjustable output device.

Another objective of the present invention is to provide an optical disk drive having a pickup head with a layer jumping function, which comprises a pickup head, a preamplifier, a controller, a target speedometer, a first adder, a gap balance calculator and a second adder; wherein the pickup head includes an objective lens and a voice coil motor, and the pickup head drives the voice coil motor to vertically move the lens object according to a drive control force. The preamplifier receives a signal outputted from the pickup head to produce a combined light refection signal and a focus error signal. The controller receives the combined reflective light signal and the focus error signal to produce a layer jumping speed signal and a focus control signal respectively. The target speedometer outputs a target layer jumping speed signal. The first adder is provided for adding the layer jumping speed signal and the target layer jumping speed signal for the output. The gap balance calculator receives the focus control signal to output the gap balance signal. The second adder is provided for adding a kickout/brake signal, a gap balance signal and an output of the first adder to output a control signal to a driver, wherein the driver controls the pickup head according to the control signal.

A further objective of the present invention is to provide a method for controlling the layer jumping of a pickup head of an optical disk drive, which comprises the steps of: determining the layer jumping speed of the pickup head according to a combined reflective light signal outputted by a preamplifier; providing a target layer jumping speed; comparing the layer jumping speed and the target layer jumping speed during the layer jumping of the pickup head to obtain the value of an error; and compensating a drive control force for the layer jumping of the pickup head according to the value of the error.

In a preferred embodiment of the present invention, the drive control force is determined according to a kickout/brake signal or a gap balance signal; wherein the gap balance signal is the DC potential of the kickout/brake signal, and the gap balance signal is obtained by differentiating a focus control signal.

In the preferred embodiment of the present invention, this method further comprises a step of averaging the combined reflective light signal.

In summation of the description above, the present invention provides a method and an apparatus for controlling the layer jumping of a pickup head of an optical disk drive capable of producing a feedback control when the pickup head jumps from a layer to another layer under the operation of a high-speed DVD optical disk drive as to enhance the stability of the pickup head of the DVD optical disk during the layer jumping.

### BRIEF DESCRIPTION OF THE DRAWINGS

FIG. 1 is a schematic view of a pickup head reading a dual-layer DVD disk;

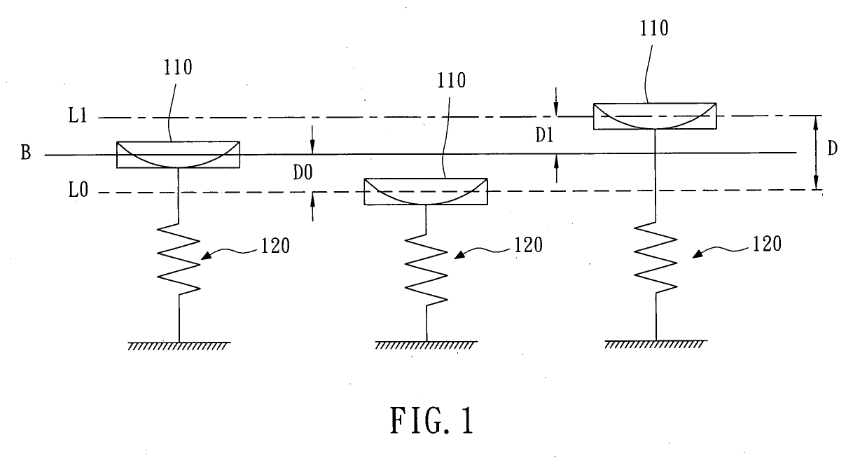

FIG. 2 is a schematic circuit diagram of controlling the layer jumping of a pickup head according to prior art;

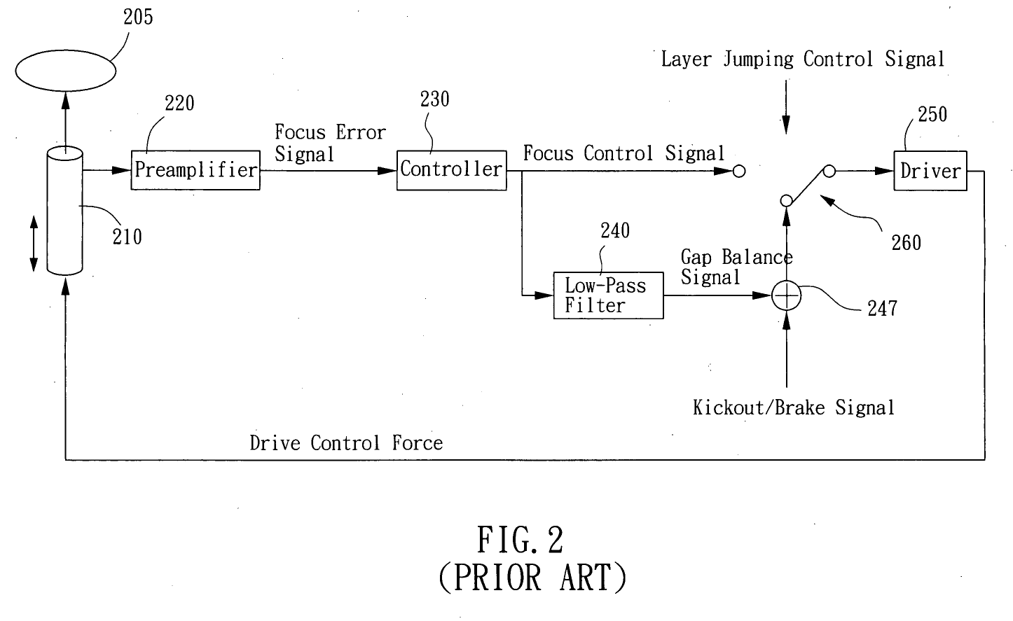

FIG. 3 is a schematic view of the control signals for the layer jumping of a pickup head as depicted in FIG. 2;

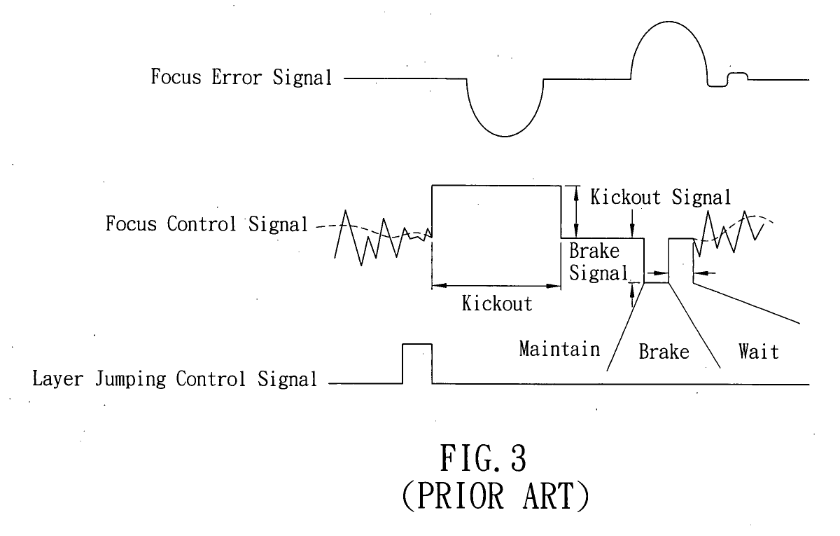

FIG. 4 is a flow chart of the method for controlling the layer jumping of a pickup head of an optical disk drive according to a preferred embodiment of the present invention;

FIG. 5 is a schematic circuit diagram of an optical disk drive with a pickup head having the layer jumping function;

FIG. 6 is a schematic view of the control signals of the layer jumping of a pickup head of an optical disk drive according to a preferred embodiment of the present invention; and

FIG. 7 is a schematic view of the modulation of a combined reflective light signal according to a preferred embodiment of the present invention.

### DESCRIPTION OF THE PREFERRED EMBODIMENT

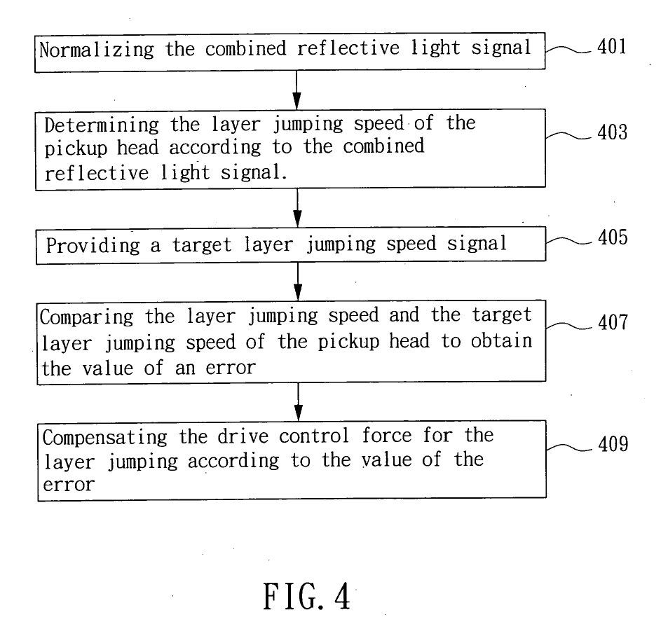

Please refer to FIG. 4 for the flow chart of the method for controlling the layer jumping of a pickup head of an optical disk drive according to a preferred embodiment of the present invention. Since the present invention makes use of a combined reflective light signal outputted by a preamplifier in the optical disk drive to determine the layer jumping speed when the pickup head jumps from a layer to another layer, therefore the combined reflective light signal is modulated first to normalize the combined reflective light signal without being affected by the properties of the optical disk and optical disk drive and give rise to a potential depth error of the combined reflective light signal. This step is referred to as Step 401.

And then, the combined reflective light signal is differentiated to obtain a layer jumping speed of the pickup head. This step is referred to as Step 403. Since the magnitude of the combined reflective light signal will vary with the layer jumping position of the pickup head when the pickup head jumps from a layer to another layer, therefore the layer jumping speed of a pickup head can be obtained by differentiating the combined reflective light signal when the pickup head jumps layers.

Further, a target layer jumping speed is provided as the basis for controlling the layer jumping speed of the pickup head. This step is referred to as Step 405. Based on Step 403, the layer jumping speed and the target layer jumping speed of the pickup head are compared to obtain the value of an error. This step is referred to as Step 407. Finally, based on Step 407, the error obtained compensates the drive control force when the pickup head jumps layers. This step is referred to as Step 409.

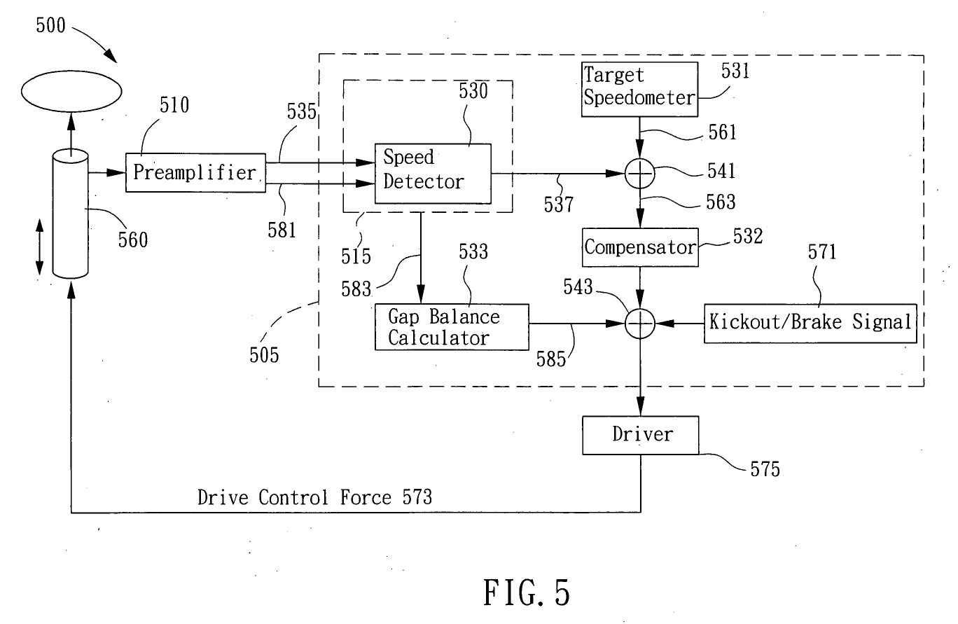

Please refer to FIG. 5 for the schematic circuit diagram of the optical disk drive with a pickup head having the layer jumping function. In FIG. 5, the layer jumping device 505 of an optical disk drive 500 comprises a speed detector 530, a target speedometer 531, a compensator 532, a gap balance calculator 533 and adders 541, 543; wherein the speed detector 530 is installed in a controller 515 and the speed detector 530 could be a differentiator as adopted in this embodiment. Therefore, the speed detector 530 can receive a combined reflective light signal 535 outputted from a preamplifier 510, and after the combined reflective light signal 535 is differentiated, a layer jumping speed signal 537 is outputted when the pickup head 560 jumps layers.

Through the target speedometer 531 (such as a multi-sectional adjustable output device), a tracking target speed 561 and a layer jumping speed signal 537 are added by the adder 541 to obtain the value of an error 563. The value of such error 532 is compensated by the compensator (such as a phase compensation) by adding the adder 543 and the kickout/brake signal 571 used by the pickup head 560 during the layer jumping, so that the driver 575 controls the drive control force as well as the feedback control of the layer jumping of the pickup head 560.

Therefore, if the kickout/brake signal 571 is used by the driver to output the control signal of the drive control force 573, the value of the foregoing error 563 compensated by the compensator 532 is outputted as a compensation to the drive control force.

To build a continuous signal for the drive control force 573 during the layer jumping of the pickup head 560 (in other words, the pickup head 560 jumps from a layer to another layer by means of the drive control force), the focus error signal 583 outputted from the preamplifier 510 after going through the controller 505 is continuous. A gap balance calculator (such as a low-pass filter) is built on the path of the focus control signal 583, such that when the pickup head 560 jumps from a layer to another layer, a gap balance signal 585 is outputted after the focus control signal 583 passes through the gap balance calculator 533. The gap balance signal 585 is used as the direct current potential for the drive control force to keep a continuous drive control force at the moment of the layer jumping of the pickup head 560.

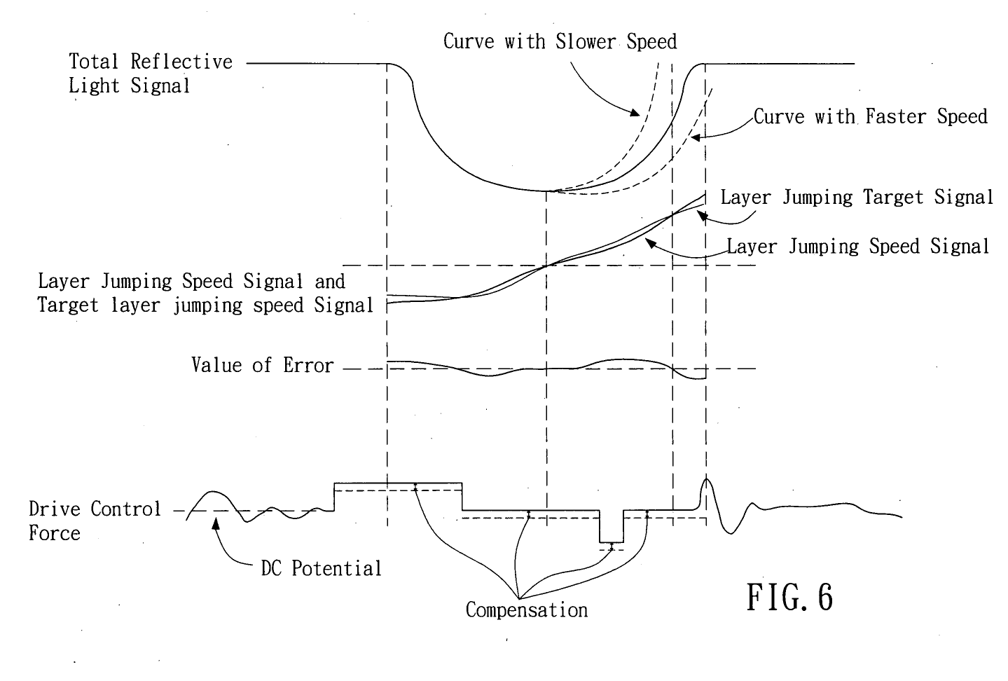

Please refer to FIG. 6 for a schematic view of the control signals for the layer jumping of the pickup head according to a preferred embodiment of the present invention. With the present invention, a combined reflective light signal is used as a basis for the layer jumping of a pickup head; wherein a combined reflective light signal has its target curve. If the curve of the combined reflective light signal has a steeper slope, it indicates that the layer jumping speed of the pickup head is faster than the target layer jumping speed. On the other hand, if the curve of the combined reflective light signal has a gentler slope, it indicates that the layer jumping speed of the pickup head is slower than the target layer jumping speed.

Based on the comparison between the layer jumping speed signal obtained after differentiating the combined reflective light signal and the user-defined target layer jumping speed signal, the value of an error can be obtained. The value obtained by compensating such error is used to compensate the drive control force for the layer jumping of the pickup head. The direct current potential obtained after the focus control signal passes through the low-pass filter can be used as the direct current potential of the drive control force for the layer jumping of the pickup head as to keep the drive control force continuous at the instance when the pickup head is jumping from a layer to another layer.

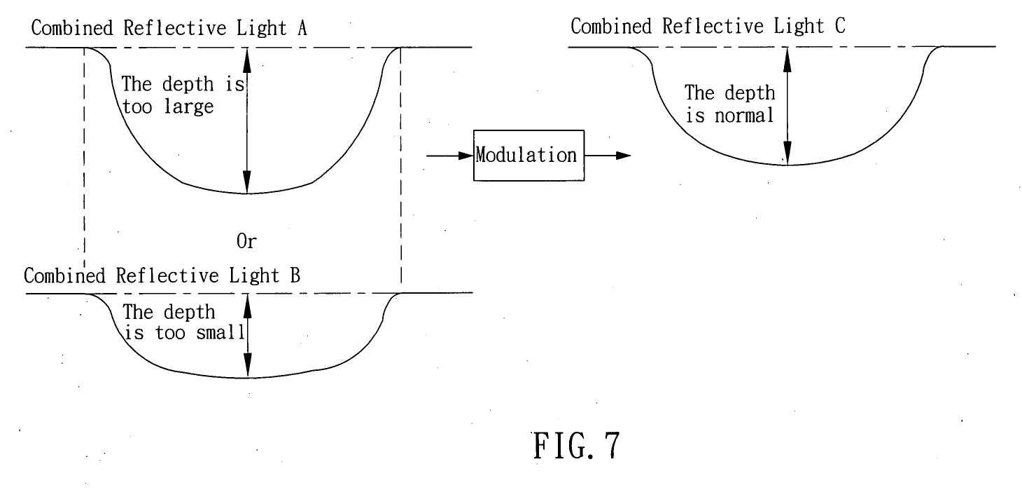

Please refer to FIG. 7 for a schematic view of the modulation of the combined reflective light signal according to a preferred embodiment of the present invention. To prevent the output of the combined reflective light from being affected by the properties of the optical disk and the optical disk drive, which may result a misjudgment of the layer jumping control if the combined reflective light is used for the feedback control of the layer jumping of the pickup head, the present invention specially averages the combined reflective light. A reflective light A with an excessively large depth or a reflective light B with an excessively small depth can be modulated to obtain a normal combined reflective light C.

The advantages of the present invention are as follows:

1. The invention makes use of the combined reflective light for the determination to provide a feedback control for the layer jumping of the pickup head. Unlike the open loop without any feedback control of a prior art, the invention adopts a close looped feedback control, and thus the displacement of the pickup head can be controlled effectively during the layer jumping of the pickup head to enhance the stability of the layer jumping of the pickup head operated in a high-speed optical disk drive.

2. The mechanism for modulating and normalizing the combined reflective light copes with different properties of the optical disk or optical disk drive, so that the layer jumping of a pickup head will not be affected by these properties, and thus the invention can enhance the stability of the layer jumping of a pickup head operated in a high-speed optical disk drive.

In view of the description above, the present invention provides a method and an apparatus for controlling the layer jumping of a pickup head of an optical disk drive, which makes use of a combined reflective light as the compensation to a drive control force for the layer jumping of the pickup head and thus further improves the stability of the layer jumping of a pickup head operated in a high-speed optical disk drive.

1. An apparatus for controlling layer jumping of a pickup head of optical disk drive, comprising:
a speed detector, for receiving a combined reflective light signal from a preamplifier to output a layer jumping speed signal;
a target speedometer, for outputting a target layer jumping speed signal;
a first adder, for adding said layer jumping speed signal and said target layer jumping speed signal;
a compensator, for receiving and compensating an output of said first adder;
a gap balance calculator, for receiving a focus control signal to output a gap balance signal;
a second adder, for adding a kickout/brake signal, said gap balance signal and an output of said compensator to output a control signal; and
a driver for controlling said pickup head according to said control signal.

2. The apparatus of claim 1, wherein said optical disk drive is a DVD drive.

3. The apparatus of claim 1, wherein said detector is a differentiator.

4. The apparatus of claim 1, wherein said target speedometer is a multi-sectional adjustable output device.

5. The apparatus of claim 1, wherein said gap balance signal is the direct current potential of said focus control signal.

6. An optical disk drive having a pickup head with a layer jumping function; comprising:
a pickup head, having an objective lens and a voice coil motor, and said pickup head driving said voice coil motor to move said objective lens vertically according to a drive control force;
a preamplifier, for receiving an output signal of said pickup head to produce a combined reflective light signal and a focus error signal;
a controller, for receiving said combined reflective light signal and said focus error signal to produce a layer jumping speed signal and a focus control signal respectively;
a target speedometer, for outputting a target layer jumping speed signal;
a first adder, for adding said layer jumping speed signal and said target layer jumping speed signal;
a compensator, for receiving and compensating an output of said first adder;
a gap balance calculator, for receiving a focus control signal to output a gap balance signal;
a second adder, for adding a kickout/brake signal, said gap balance signal and the output of said compensator to output a control signal; and
a driver for controlling said pickup head according to said control signal.

7. The optical disk drive of claim 6, wherein said optical disk drive is a DVD drive.

8. The optical disk drive of claim 6, wherein said controller further comprises:
a speed detector, for receiving said combined reflective light signal to output said layer jumping speed signal.

9. The optical disk drive of claim 8, wherein said speed detector is a differentiator.

10. The optical disk drive of claim 6, wherein said target speedometer is a multi-sectional adjustable output device.

11. The optical disk drive of claim 6, wherein said gap balance signal is the direct current potential of said focus control signal.

12. A method for controlling layer jumping of a pickup head of an optical disk drive, comprising:
determining a layer jumping speed of the pickup head according to a combined reflective light signal outputted from a preamplifier;
providing a target layer jumping speed;
comparing said layer jumping speed of said pickup head and said target layer jumping speed to obtain the value of an error; and
compensating a drive control force for layer jumping of said pickup head according to the value of said error.

13. The method of claim 12, wherein said drive control force is provided according to a kickout/brake signal.

14. The method of claim 13, wherein said drive control force is provided according to a gap balance signal and said gap balance signal is a direct current potential of said kickout/brake signal.

15. The method of claim 14, wherein said gap balance signal is obtained by differentiating a focus control signal.

16. The method of claim 12, further comprising: averaging said combined reflective light signal.
